(19) United States
(12) Patent Application Publication
(10) Pub. No.: US 2014/0225748 A1
(43) Pub. Date: Aug. 14, 2014

(54) Power Transmission System and Method using a Conducting Tube

(71) Applicant: Kenneth Wilson, Tyler, TX (US)

(72) Inventor: Kenneth Wilson, Tyler, TX (US)

(21) Appl. No.: 14/176,048

(22) Filed: Feb. 8, 2014

Related U.S. Application Data
(60) Provisional application No. 61/762,338, filed on Feb. 8, 2013.

(51) Int. Cl. G08C 17/04

(52) U.S. Cl. CPC G08C 17/04
USPC 340/870.31

(57) ABSTRACT

A system and method for improving power transmission is disclosed. Specifically, a system for improving power transmission can comprise a transmission pipe, a first transceiver, and a second transceiver. The transmission pipe can comprise a fluidic pipe and have a first length. The first transceiver can be connected to a proximal end of the transmission pipe. The second transceiver can be connected to a distal end of the transmission pipe, and each of said transceivers can be configured to communicate by a signal having a wavelength equal to two times the length of the transmission pipe, divided by an integer greater than or equal to one.

### FIELD OF THE DISCLOSURE

This disclosure relates to an improved power transmission system and method using a conducting tube. For purposes of this disclosure, variations are discussed, and are an example of an improved power transmission system and method. However, such discussion is solely exemplary, and not limiting.

### BACKGROUND OF THE INVENTION

In a variety of applications, many of which are terrestrial in nature (geological applications, piping, fluid transmission, drilling applications, long distance communication involving pipelines) and require some type of electromagnetic transmission through the earth it has become apparent that a variety of electromagnetic principles have not yet been incorporated to optimize the potential of electromagnetic transmission in these areas of application. Currently, there is an increased desire to locate certain zones where a particular resource (heat/steam, drinking water, trapped gases such as CO2, oil, natural gas etc.) might be found. Electromagnetic energy can be useful in applications where it is currently difficult to obtain or limited in supply. However, the standard methods of transmission are largely limited to low frequency applications and therefore are not optimized.

In industries where fluids (in the physics sense of the word, fluid signifies any liquid or gas regardless of its molecular constituents) are piped over what is (currently) considered long distances such as from a hundred yards to miles, particularly, but not limited to subterranean locations, electromagnetic energy (AC power) is considered a valuable commodity. Currently, forms of transmission include the use of metal cables and fiber-optics etc. for electromagnetic communication applications. However, these methods require the use of an additional cable of some sort. One advantage of using a fluidic pipe as a transmission line is that no other cable is required. This also means that no other cable can break or get caught and break on some fixture during installation or any other time. In applications where external cables are still applicable, the use of the pipe can be for redundancy in the event that the cable malfunctions.

Application areas can include the transmission of AC power or telemetry such as data or the sending of control signals to open and/or closing a valves and other such commands. This technology can be applied to a variety of industries such as geothermal applications where steam from the earth turns a turbine to generate power. In such an application it might be important to provide power to open or close a valve or turn on a pump and communicate temperature data to ensure the steam does not melt components and the ability to choke/close a valve to regulate power generation. Additionally, the same type of applications would be applicable in the pumping of water from terrestrial areas such as aquifers via a pipeline to land surface. Other areas can extend to gas piping such as carbon dioxide and other gases that are commonly transmitted over many miles. In the United States, it is common that Kinder Morgan (and other such companies) transmits CO2 over many states. This example in regards to carbon dioxide is specifically mentioned to clarify that the transmission of a “gas” is not limited to the oil and “gas” industry where gas usually means the molecule methane or other such hydrocarbon gases. The application of the technology could apply to any industry where a fluid is transmitted over great lengths with the need for accompanying data or operations commands.

### SUMMARY

A system and method for improving power transmission is disclosed. Specifically, a system for improving power transmission can comprise a transmission pipe, a first transceiver, and a second transceiver. The transmission pipe can comprise a fluidic pipe and have a first length. The first transceiver can be connected to a proximal end of the transmission pipe. The second transceiver can be connected to a distal end of the transmission pipe, and each of said transceivers can be configured to communicate by a signal having a wavelength equal to two times the length of the transmission pipe, divided by an integer greater than or equal to one.

A method for improving power transmission can comprise transmitting a signal from a first transceiver positioned on a proximal end of a transmission pipe to a second transceiver positioned on a distal end of said transmission pipe. The transmission pipe can comprise a length equal to a wavelength of said signal, multiplied by an integer greater than 0, and divided by two.

### BRIEF DESCRIPTION OF THE DRAWINGS

FIG. 1A illustrates a first graph with an instantaneous distribution of voltage along a semi-infinite line including a resistance on the line S.W at distance (D)=π/2, 3π/2, 5π/2, etc.

FIG. 1B illustrates a second graph with an instantaneous distribution of voltage along a semi-infinite line including a resistance on the line S.W at distance (D)=π, 2π, 3π, etc.

FIG. 2 illustrates a power transmission system buried under a terrestrial surface.

FIG. 3 illustrates an embodiment of transceivers affixed to transmission pipes.

### DETAILED DESCRIPTION

Described herein is an improved power transmission using a conducting tube system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure.

Accordingly, the claims appended hereto are not intended to be limited by the disclosed embodiments, but are to be accorded their widest scope consistent with the principles and features disclosed herein.

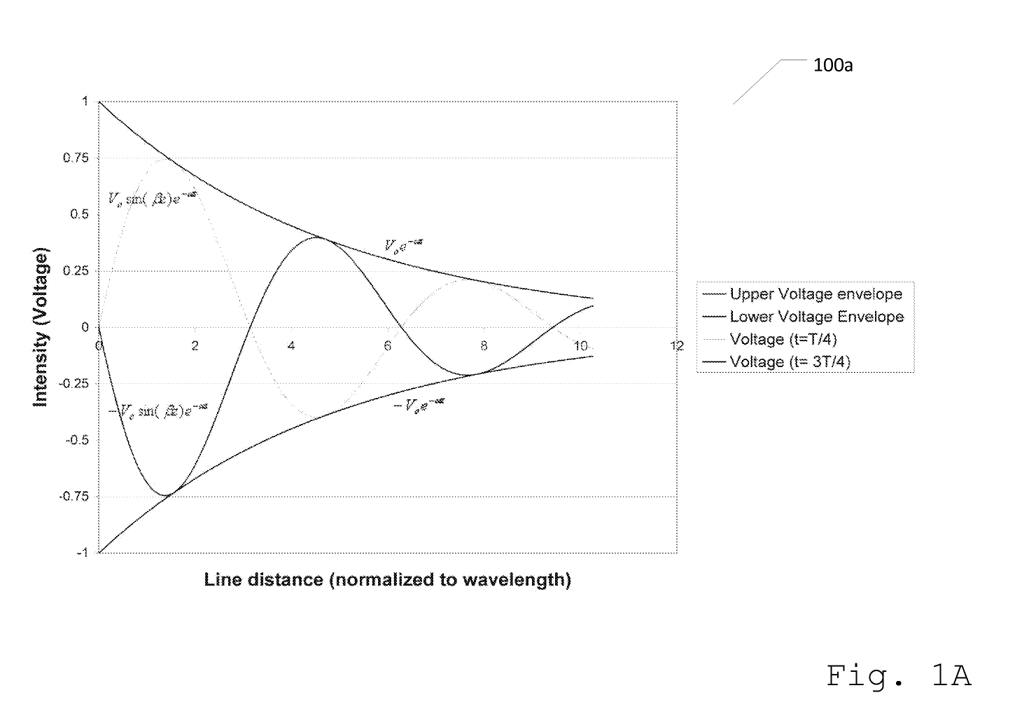

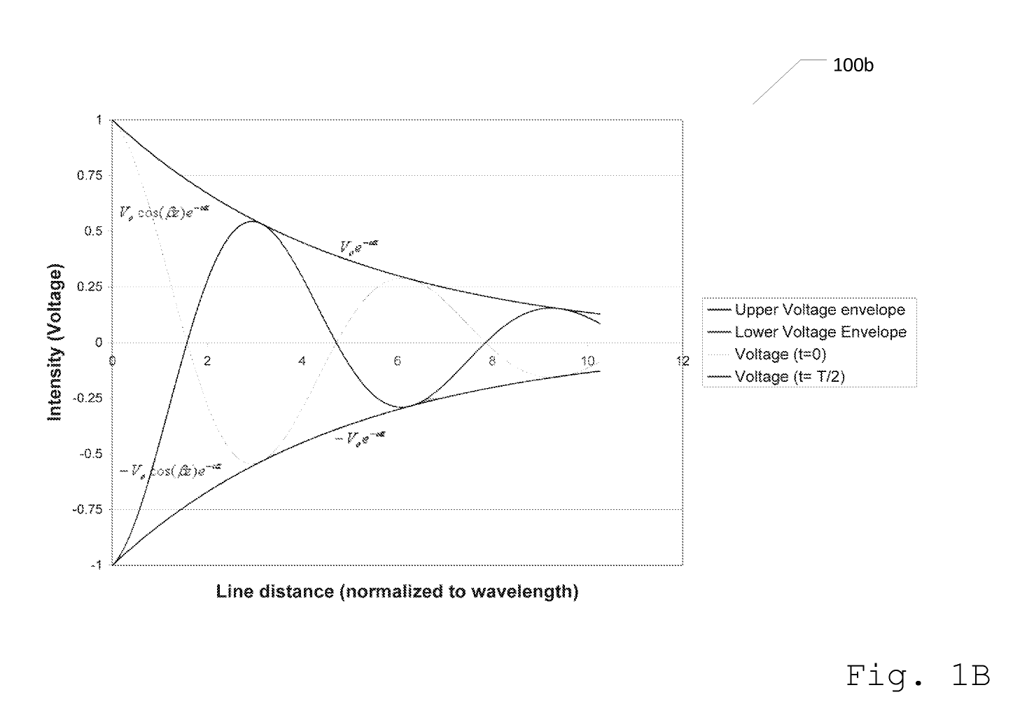

FIG. 1A illustrates a first graph 100a with an instantaneous distribution of voltage along a semi-infinite line including resistance on the line S.W at induction (L)=π/2, 3π/2, 5π/2, etc. FIG. 1B illustrates a second graph 100b with an instantaneous distribution of voltage along a semi-infinite line including resistance on the line S.W at induction (L)=π, 2π, 3π, etc.

Previous work in the area of using a pipe, as a transmission line was not appropriately utilized. A standard wave equation is generally used to describe standing waves in electromagnetics. In the use of transmission line theory as it relates to electromagnetic waves, the use of a standard wave equation might be applicable to lossless transmission lines and waveguides. A lossless transmission line is one whose resistance is considered exceptionally low or approximated as zero. In theory, many such transmission lines exists, however, a transmission line in practice with insignificant resistance is not practical. A high frequency and short distance line or a low frequency long distance line might be considered lossless. These assumptions can be made at what is considered low frequencies (˜60 Hz or 100 Hz), because no consideration is given to the skin effect, which is related to frequency. In order to increase power transmission, one fights a losing battle as a result of eddy currents produced in the transmission line. Eddy currents result in the power being dissipated as heat is equated as resistive losses. When this happens the assumptions that allow for the lossless transmission line are no longer valid and therefore, the standard wave equations are no longer valid. The resulting governing equation would then be given as, Equation (1):

$$\frac{{\partial }^{2} V ( z , t )}{\partial {z}^{2}} = RGV ( z , t ) + ( RC + LG ) \frac{\partial V ( z , t )}{\partial t} + LC \frac{{\partial }^{2} V ( z , t )}{\partial {t}^{2}}$$

$$\frac{{\partial }^{2} I ( z , y )}{\partial {z}^{2}} = RGI ( z , t ) + ( RC + LG ) \frac{\partial I ( z , t )}{\partial t} + LC \frac{{\partial }^{2} I ( z , t )}{\partial {t}^{2}}$$

The inclusion of the resistance term can be significant when trying to transmit over “long” distances. The standard wave equation omits the resistance term. This is why it might be applied to waveguides. In a waveguide there is no resistance. The transmission medium is considered the air inside the guide. Along a practical transmission line, at a moderate frequency, the telegrapher/resistance effects must be considered. The resistance of such a line must be modified. Direct current (DC) resistance can be given as R=ρL/A. However, for a pipe with an alternating current (AC) field, it can be approximated by (Cohn, Formula and tables for the calculation of alternating current problem), Equation (2):

$$R = {R}_{0} \{ 1 + \frac{1}{12} \frac{{w}^{2} {l}^{2} {μ}^{23}}{{R}_{0}^{2}} - \frac{1}{180} \frac{{w}^{4} {l}^{4} {μ}^{4}}{{R}_{0}^{4}} + … \} S = \vert V max \vert$$

At higher frequencies, transmission lines have an increased resistance. From a mathematical point of view, the wave equation omits the first order time component (the exponential decay function). The resulting implication in the omission of the resistance term is that electromagnetic waves could be transmitted over thousands of miles in a metallic transmission line with no loss. FIGS. 1A and 1B indicate the nature in which a transmitted signal decays in a transmission line with resistive loss. Equation 2 demonstrates an increase in resistance of a pipe, which is directly proportional to frequency. Such an implication of a lossless transmission line is not feasible as frequency increases. It is therefore more appropriate to use Equation 1 as the governing equation.

The need for shorter wavelengths would allow for the optimization of power transmission via the voltage standing wave ratio, S, which is related to the voltage reflection coefficient, γ (which is a function of the termination load of the transmission line, the wavelength: distance ratio, and the characteristic impedance of the line) and directly results in power losses when not optimized. The Voltage standing wave ratio is given as:

$$S = \frac{\vert {V}_{max} \vert}{\vert {V}_{min} \vert} = \frac{1 + \vert Γ \vert}{1 - \vert Γ \vert}$$

In order to maximize power transfer, the wavelength must be proportional to the transmission distance, which is known in antenna applications. This allows for a standing wave. If it were economically feasible, all antennas would use this characteristic. If conditions for a standing wave do not exist, then there can be a reflected wave, which can in turn interfere with the transmitted wave and diminish the magnitude of the propagating signal. The reflection coefficient is given as:

$$Γ = \frac{{Z}_{L} - {Z}_{0}}{{Z}_{0} + {Z}_{L}} = \frac{S - 1}{S + 1}$$

Here Z_{L} is the load (termination) impedance and Z₀ is the characteristic impedance of the transmission line which is given as:

$${Z}_{0} = \frac{R + jω D}{γ} = \frac{R + jω D}{G + j ω C}$$

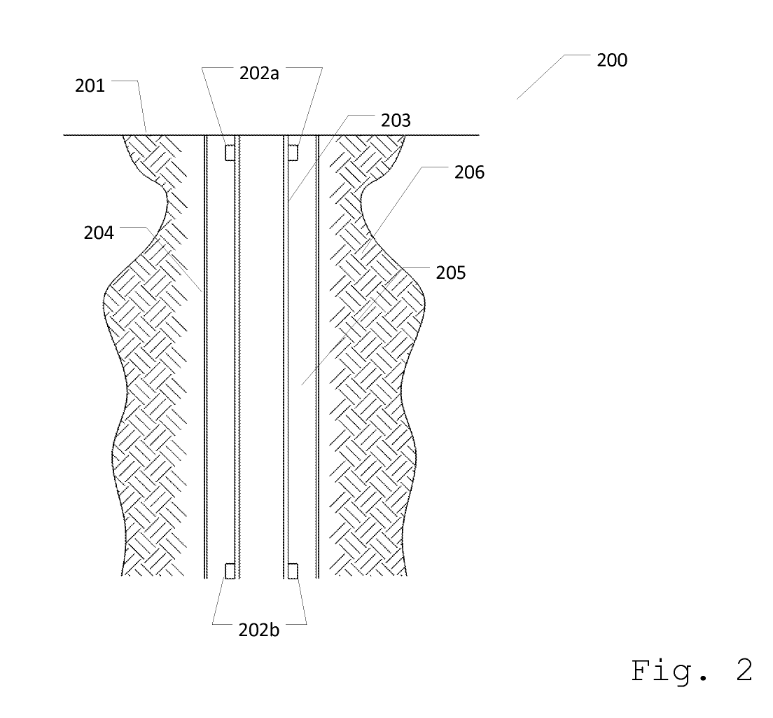

In this equation, R is resistance, G conductance, D induction, and C is capacitance. It should be pointed out that in the case of a pipe as a transmission line that all the characteristic values are dependent on the appropriate equations such as Equation 2 for Resistance. Other equations exist in literature for the induction and capacitance of a pipe. As a note on standing waves, it can be shown from the equation 1 that standing waves exist in both free space (on an infinite transmission line) and on a finite line at a distance that is a multiple of the half-wave carrier wavelength. This property can also be observed in FIGS. 1 and 2. A wave can always demonstrate superior reflection coefficient (all other factors remaining equal) when its termination distance is located at the half-wavelength location. That is to say:

$$L = n \frac{λ}{2}$$

$$n = 1 , 2 , 3 , 4 , …$$

It was noted that at AM broadcast frequencies a single half-wavelength antenna would be over a hundred meters long. The technology described here serves to use the benefits of this statement. The reason antennas are not as long is the fact that the cost would be tremendous. Generally, techniques are employed to minimize the need for the size of such an antenna. Fortunately, there are such industries where the necessary long antenna of such length exists. These are the industries described in the field of the invention section. It is desirous to minimize the reflected wave, which causes this power loss. In doing so, one would raise the frequency. This in turn raises the characteristic impedance of the transmission line [ref]. This non-standard resistance must be taken into account when considering transmission (see Equation 2).

Capacitance, Induction, and conductance all have similar equations that are distance and frequency dependent. In practice the pipes can be measured with commercial instruments to obtain their parameters at a given frequency. Such measurements are a common practice. Depending on the size of the fluid carrying tube, the characteristic parameters should vary greatly. It would therefore be necessary to know each individual case rather than try to generalize the characteristic impedance of (for instance) a 5 inch pipe inside a 7 inch pipe vs. a 7 inch pipe inside a 9 ⅝ inch pipe. Once the parameters are obtained for the specific application based transmission line of given dimensions and a given material certain calculations can be made. At this point, the considerations regarding a transmission line terminated at a finite length can be considered. The voltage, current, and load at a location z′ on a terminated transmission line are given as:

$$V ( {z}^{′} ) = \frac{{I}_{L}}{2 {Z}_{0}} [ ( {Z}_{L} + {Z}_{0} ) {e}^{γ {z}^{′}} - ( {Z}_{l} - {Z}_{0} ) {e}^{- γ {z}^{′}} ]$$

$$I ( {z}^{′} ) = \frac{{I}_{L}}{{Z}_{0}} ( {Z}_{L} sinh y {z}^{′} + {Z}_{0} cosh {yz}^{′} )$$

$${Z}_{0} ( {z}^{′} ) = {Z}_{0} \frac{{Z}_{L} + {Z}_{0} tanh {yz}^{′}}{{Z}_{0} + {Z}_{L} tanh {yz}^{′}}$$

It is then noted that when a finite transmission line is matched (Z₀=Z_{L}), the voltage and current distributions are exactly the same as though the line has been extended to infinity. This is considered the optimized case.

$${Z}_{i} = {( {Z}_{i} )}_{\begin{matrix}z = 0 \\ {z}^{′} = l\end{matrix}} = {Z}_{0} \frac{{Z}_{L} + {Z}_{0} tanh γ l}{{Z}_{0} + {Z}_{L} tanh γ l}$$

It is not the purpose here to give a complete synopsis on the derivations of such equations. The equations themselves have been derived extensively. The equations are used in practice through a tool known as Smith Chart. The mathematical manipulation necessary for these calculations is complex. The Smith Chart has basically taken care of the calculations for the user. The important improvement here is that the parameters need to be the modified R, C, D, and G for the pipe geometry. The applications to which these improvements apply can include using the transmitted power to harness energy such as charging a battery, operate an electric pump, valve or other such equipment like surveying equipment that needs electricity. Additionally, these topics can be extended to include telemetry. A special discussion should be made about telemetry. As a byproduct of power transmission and the need to include the resistance (exponentially decaying term) in the line it was noted that Equation 1 is therefore the governing equation. The equation is referred to as “The Telegrapher's Equation”, which is used in telemetry. It is appropriately labeled the “telegrapher's equation” because it has been the governing equation of telemetry since prior to the previous century. It correctly described the physics of a signal in the days when telegraphs were the primary mode of distance communication. Standard wave equations cannot in general describe the fact that waves do not propagate forever, nor do they propagate across exceptionally long distances. When trying to describe telemetry, it should be noted that the physics of telemetry exists via the use of “on off” type signals that are sent. In the case of frequency shifting a higher frequency is considered a “1” and a lower frequency is a “0”. In phase shifting a “sine wave” is sent as a “1” and a corresponding “cosine wave” (which is out of phase with the original wave and thus the name phase shifting) would correspond to zero. Such a variety of schemes exist that there are too many to discuss here. What is of note is that all of these such schemes are carrier signal and the “0” carrier signal. As such, telemetry by its very nature cannot be considered a “standing wave” and therefore the standard wave equations would not apply.

FIG. 2 illustrates a power transmission system 200 buried under a terrestrial surface 201. Power transmission system 200 can comprise a pair of transceivers 202, and a plurality of transmission pipes 203 covered through a casing 204. Transceivers 202 can be a device capable of transmitting and receiving electromagnetic waves with encoded data at a wide range of wavelengths. As such transceiver 202 can comprise a transmitter and a receiver. Transmitter 202 can produce electro magnetic waves for the purpose of power transmission to be harnessed at a receiver location. A first transceiver 202a can be attached at the top of transmission pipes 203 while a second transceiver 202b can be attached at the bottom of transmission pipes 203.

Transmission pipes 203 can comprise one or more pipes. Transmission pipes 203 can be used in pumping a fluid from the bottom of transmission pipes 203 to the top of transmission pipes 203, in one embodiment. In another embodiment, transmission pipes 203 can transfer fluid from the top of transmission pipes 203 to the bottom of the pipes. In one embodiment, transmission pipes 203 can be a hollowed out electrically conducting tube comprising of metallic pipe. As such, transmission pipes 203 can be buried under terrestrial surface 201 and can be generally used in fluidic applications such as recovering hydrocarbons. In another embodiment transmission pipes 203 can be an annular conducting tube system. In such embodiments, a wave generator can pass an electromagnetic wave, which enables electromagnetic power transmission or telemetry communication whereby strategic placement of the receiving location produces and improves transmission.

Casing 204 can be protective enclosure for transmission pipes 203. Casing 204 prevents a formation 206 to collapse against transmission pipes 203. This can be a possible case when the transmission distance is exceptionally long; the mechanical properties of the pipe and the earth formation take over. An annulus 205 can be the created void in between transmission pipes 203 and casing 204. A fluidic material 207 can fill annulus 205 to balance pressure and create a buoyancy effect enabling the running of more pipes to have a lower apparent weight and less stress, in on embodiment.

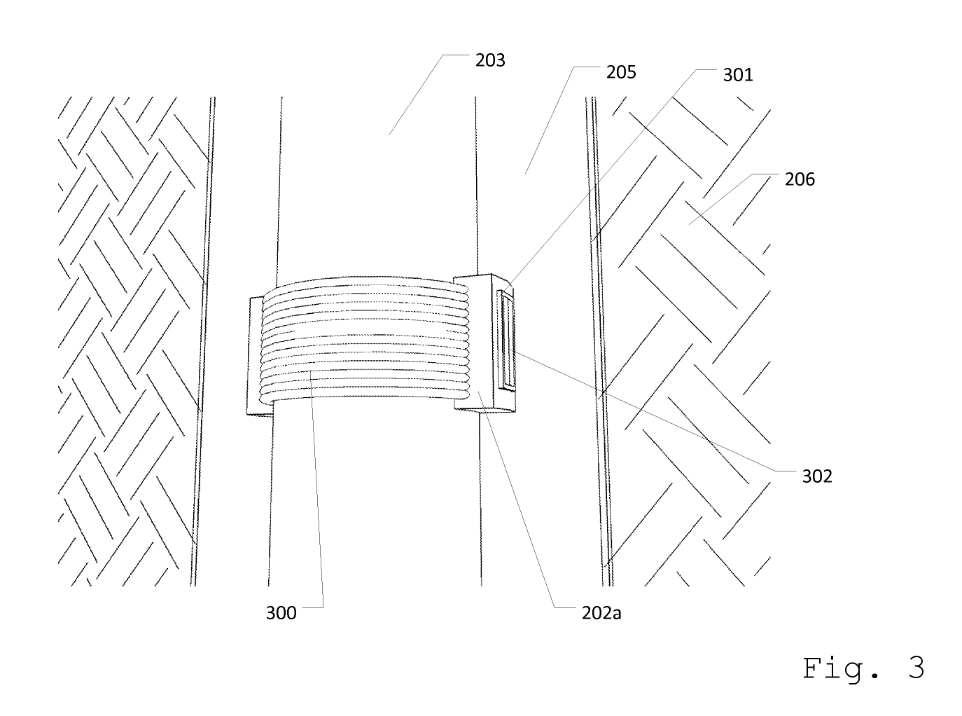

FIG. 3 illustrates an embodiment of transceivers 202 affixed to transmission pipes 203. Transceivers 202 can be attached to transmission pipes 203 in various ways. In one embodiment, transceivers 202 can be wrapped around transmission pipes 203 in a loop manner through a coil 300 such as a Helmholtz coil. For purposes of this disclosure, Helmholtz coil can be a convenient material for producing a smooth field. A series of castillations can be cut into transmission pipes 203 and coil 300 can be wrapped around the individual castillations, or the signal can be attached directly to transmission pipes 203 in the manner low-frequency experimental radio (LowFERs) attach a coil.

Further, second transceiver 202b can be at a position wherein power transmission can be difficult while first transceiver 202a can be at an accessible location for transmitting and receiving power transmission. In such setup, second transceiver 202b can comprise a power source 301 and a microprocessor 302. Power source 301 can be capable of producing sufficient current necessary for power transmission. Furthermore, power source 302 can be used to supply power to second transceiver 202b. Power source 301 can include but are not limited to battery, battery pack, or generator wherein power can be produced by a moving fluid. As such, power source 301 can be installed on transmission pipes 203 in different positions, such as on the pipe, near the pipe, inside the pipe or concentrically around it. Microprocessor 302 can be capable of decoding received data commands that then send commands to equipment such as valves, pumps, etc.

As an example, the deepest well in the world is currently between 12,000 and 13,000 meters. Therefore, a lower end of the transmission wavelength would be ˜26,000 m (or 11.5 kHz). The upper end of the transmission capability would be in the range at which waveguides are used ˜10 cm (3 GHz), however these would correspond to shorter transmission distances. Transceivers 202 can be separated by a distance, which corresponds to integer multiples of the transmitting carrier wavelength λ/2 along transmission pipes 203. Second transceiver 202b can send the time varying electromagnetic waves to first transceiver 202a. The receiver can be appropriately schemed to insure that it has a minimal reflection coefficient. This may mean that the receiving load is physically located at a particular distance to ensure its reflection is minimized or it may mean that the receiving circuit is appropriately tuned to the transmission frequency (similar to how any radio operator tunes to the appropriate channel). As a matter of practicality, the receiving circuit at the top of transmission pipe 203 can be more accessible and can therefore be capable of being tuned. For this reason, it is in general that when telemetry is necessary to be sent, second transceiver 202b can be sending out a specific wavelength and first transceiver 202a can be tuned to that wavelength. First transceiver 202a can have the receiving circuit with the ability to tune to the appropriate load. Should second transceiver 202b be moved farther into the hole (or pulled out of the hole for some reason), its characteristic impedance could then be changed and first transceiver 202a can have the ability to send data to second transceiver 202b telling second transceiver 202b to modify any carrier wavelength first transceiver 202a transmits. Because first transceiver 202a is tuned to the appropriate load and wavelength, the corresponding distance can be correlated from the telegrapher's equation or in some cases with the aid of a Smith Chart. Such information can have the ability to command second transceiver 202b to transmit the data back to first transceiver 202a on a different carrier wavelength if necessary. Two-way communication allows for a continually adjustable system to operate with minimum reflection coefficients. The preceding description is important to make sure that both the transmitter and receiver aspect of the system are appropriately tuned to the identical characteristic loads. Notice the desired effect is not necessarily low or zero loads as described elsewhere. The desired effect is an identical load to ensure correct reflection coefficients. It is at this point that, when appropriately tuned, the system is then capable of transmitting larger amounts of power if desired.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments can be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for improving power transmission comprising
a transmission pipe comprising a fluidic pipe, said transmission pipe having a first length; and
a first transceiver connected to a proximal end of said transmission pipe; and
a second transceiver connected to a distal end of said transmission line, each of said transceivers configured to communicate by a signal having a wavelength equal to two times said length, divided by an integer greater than or equal to 1.

2. The system of claim 1 wherein said integer is equal to or less than 20.

3. The system of claim 1 wherein said integer equals 1.

4. The system of claim 1 wherein said integer equals 2.

5. The system of claim 1 wherein said integer equals 10.

6. The system of claim 1 wherein said first length is greater than 200 feet.

7. The system of claim 1 wherein said first length is greater than 1,000 feet.

8. The system of claim 1 wherein said first length is greater than 10,000 feet.

9. The system of claim 1 wherein said first transceiver capable of sending data to said second transceiver to modify said wavelength second transceiver transmits.

10. The system of claim 1 wherein said second transceiver are capable of transmitting data back to first transceiver on a second signal having a second wavelength, said second wavelength different from said wavelength.

11. The system of claim 1 wherein said transmission pipe comprises a characteristic impedance, further wherein said transmitters are matched to said characteristic impedance of said transmission line.

12. The system of claim 1 wherein said transmission pipe is capable of transmitting hydrocarbons while said transmitters are communicating.

13. The system of claim 1 wherein each of said transceivers comprises coils that are each wrapped around said transmission pipes.

14. The system of claim 13 wherein said coils comprise a Helmholtz coil.

15. A method for improving power transmission comprising the step
transmitting a signal from a first transceiver positioned on a proximal end of a transmission pipe to a second transceiver positioned on a distal end of said transmission pipe, said transmission pipe comprising a length equal to a wavelength of said signal, multiplied by an integer greater than zero, and divided by two.
